(19) United States
(12) Patent Application Publication
(10) Pub. No.: US 2024/0174499 A1
(43) Pub. Date: May 30, 2024

(54) Method and System for Load Detection in an Industrial Truck

(71) Applicant: STILL GmbH, Hamburg (DE)

(72) Inventors: Marina Ignatov, Kiel (DE); Sebastian Smolorz, Hannover (DE); Volker Viereck, Kühsen (DE); Abel Bengt, Lüneburg (DE); Dennis Schüthe, Buchholz (DE)

(21) Appl. No.: 18/285,047

(22) PCT Filed: Mar. 1, 2022
(86) PCT No.: PCT/EP2022/055076

§ 371 Date: Sep. 29, 2023

(30) Foreign Application Priority Data
Mar. 31, 2021 (DE) 10 2021 108 186.6
Apr. 16, 2021 (DE) 10 2021 109 613.8

(51) Int. Cl. B66F 9/075; B64U 101/00; B64U 101/25

(52) U.S. Cl. CPC B66F 9/0755; B64U 2101/00; B64U 2101/25

(57) ABSTRACT

A method for the determination of a load on an industrial truck (2, 3, 4) and a system (1) for the performance of the method are disclosed. The load (L) is detected by at least one optical sensor (S) and is determined by analysis of the sensor data by means of artificial intelligence in at least one data processing unit (D).

### CROSS-REFERENCE TO RELATED APPLICATIONS

This application is the United States national phase of International Application No. PCT/EP2022/055076 filed Mar. 1, 2022, and claims priority to German Patent Application Nos. 10 2021 108 186.6 filed Mar. 31, 2021 and 10 2021 109 613.8 filed Apr. 16, 2021, the disclosures of which are hereby incorporated by reference in their entireties.

### BACKGROUND OF THE INVENTION

### Field of the Invention

This invention relates to a method for the determination of a load on an industrial truck and a system for the performance of the method.

### Description of Related Art

Industrial trucks are used for the transport and/or handling of loads. One example of this activity is order picking. Order picking means all methods for the collection of specified load objects, in particular of general cargo or piece goods, e.g. packages, in warehouses from an available overall selection. As part of this process, load objects must be collected on the basis of work orders, e.g. orders from customers or production orders. Recently, automated systems have come into increasing use for this purpose. In these automated systems, the piece goods are manually collected by order picking personnel or by autonomously operated transport vehicles from a source position, in particular a source cargo carrier such as a source pallet, for example, and placed on a target cargo carrier, e.g. a target pallet, transported on the vehicle. For this purpose in particular, mobile order picking robots are used which can independently pick up the piece goods themselves by means of robot arms. These mobile order picking robots automatically receive the work order data such as the work order number, the coordinates of the storage location, the number of pieces and weight of the piece goods from a central computer. For example, mobile order picking robots can travel to specified compartments or rack locations in rack storage warehouses and remove the desired load object from the compartment by means of a handling device, in particular a gripper system with a pickup tool. The pickup tool can be in the form of a gripper, for example an adhesive gripper or a vacuum gripper.

The vehicles used for order picking are usually self-driving or are in the form of an autonomous vehicle, also called an automated guided vehicle (AGV), and generally have a lifting mast or another lifting device for the vertical positioning of the gripper in the rack and on the target parcel.

The loads to be transported are generally not standardized. Therefore the loads generally differ in terms of the following factors: weight, weight distribution, height, width, depth, number of individual load objects, three-dimensional distribution on the loading deck of the industrial truck, center of gravity of the load in the application axis (vertical Z-axis), horizontal load center etc.

The above mentioned factors above are also dynamic. The factors of a load change constantly, especially during order picking. These changes cause problems in the pickup of the load by autonomous industrial trucks because the factors cited above are decisive in determining whether a load may be picked up by an AGV at all. A load overhang, in which the load projects beyond the contour of the pallet, plays a particularly decisive role, because pallets with an undetected overhanging load cannot be handled without additional measures. For example, it may not be possible to identify a suitably large rack space on a rack, nor can safe transport be guaranteed because the overhanging load could lead to an indirect widening of the AGV, which would make personal protection impossible in compliance with the applicable regulations.

These factors relating to the load being transported also play a role in the performance of AGVs. Both the speed, the cornering angle as well as the safety aspect are designed on the basis of the factors of a load. If these factors are unknown, the worst case must be assumed.

Currently, there is no known solution for the determination of all factors of a load to be transported.

Separate stationary contour check stations are frequently used to ensure that the load does not project beyond the edges of the pallet. After the goods have been received, the industrial truck transporting the load first directly approaches these contour check stations to ensure safe onward transport of the load with the industrial truck. However, that entails a time-consuming transport process for each individual pallet.

Overall, it has been found that overhanging loads represent a complex and expensive problem in every automated warehouse. Extra and expensive load contour check stations must be constructed and driven through with every new load that arrives before safe automated handling of the load with the industrial truck can be guaranteed. In the absence of such load contour check stations, a corresponding inspection must be conducted manually.

The weight and the weight distribution of a load can be determined by additional sensor systems, in particular by weight sensors.

Not all of the other load factors can be determined by simple sensor systems.

For safety reasons, therefore, the process is often based on the assumption of a binary load. A binary load means that either a load is or is not on the industrial truck. However, this assumption represents an extreme restriction in terms of the safety and performance of the industrial truck.

But even this performance restricted by the binary load determination can be realized only with additional cables and wiring directly on the cargo area of the industrial truck. However, cables and wires are always problematic on industrial trucks with mobile platforms, in particular on autonomous mobile platform trucks with a lifting platform that can be raised and lowered to transport the load. On one hand, the cable length can be problematic on account of the data transmission. On the other hand, cables on moving parts, e.g. on a lifting platform, always represent a risk of fire caused by crimped or crushed cables and wires.

Autonomous industrial trucks frequently organize incoming goods by picking up pallets. However, this is possible only if all three dimensions of the load are known, i.e. the width, height and depth. Otherwise the pallet is not picked up.

A major problem in order picking is the manual or automated pickup of incorrect loads. The resulting costs of such errors are enormous.

### SUMMARY OF THE INVENTION

The object of the present invention is to configure a method to determine the load on an industrial truck as well as a system for the performance of the method so that reliable load determination is guaranteed even for loads with a complex structure that are being transported by an industrial truck.

This object is accomplished by the method according to the invention in which the load is detected (captured) by at least one optical sensor and is determined (recognized, identified) by evaluation of the sensor data from the sensor by means of artificial intelligence in at least one data processing unit.

The optical sensor used is appropriately a camera. The camera can in particular be a compact camera module that can be used flexibly. Even cell-phone cameras, for example, represent adequate quality for the purpose.

The camera makes the necessary sensor data available for evaluation in the data processing unit. The evaluation of the sensor data in the data processing unit is advantageously performed by means of an imaging process. Artificial intelligence methods are used for this purpose.

In recent years, artificial intelligence (AI) has demonstrated excellent capabilities in the identification, evaluation and classification of the objects in a load. Small, powerful computers that are designed to use simple peripheral AI applications and devices already exist.

The optical sensor can be carried on board the industrial truck itself. The sensor used is preferably a sensor located on a lifting device of the industrial truck, for example on the upper end of a lifting mast. Locating the optical sensor on the lifting device on the lifting device means that the sensor can detect the industrial truck and any load that may be on loading platform of the industrial truck, for example, from a higher position.

Additionally or alternatively, a sensor located outside the industrial truck can also be used as the optical sensor.

In that case, the optical sensor can be attached to an infrastructure element in the vicinity of the operation of the industrial truck. For example, the sensor can be located on a mast at a greater height so that it can effectively detect the industrial truck and the corresponding load.

Preferably, an optical sensor in the form of a movable sensor is used that can be moved around the industrial truck and the load and thereby detect the industrial truck and the load from different directions. The determination of the load and the analysis of the sensor data in the data processing unit are thereby made easier. For example, a sensor carried by an operator can be used for this purpose. The sensor in question can thereby be a BodyCam or a HeadCam, so that smart glasses or virtual reality glasses can be used.

According to one particularly preferred embodiment of the invention, the sensor is carried by an aerial drone. Aerial drones are already known for other applications. The use of drones has become increasingly common in various sectors in recent years. Aerial drones are both a popular hobby and are used in the professional and industrial sectors. Other benefits from the use of aerial drones include their maneuverability, powerful cameras and ability to link with other computers and smartphones. Aerial drones have also been adopted in the logistics sector, e.g. to inventory warehouses, and consideration is also being given to their future use in the delivery of packages, for example. Industrial drones employing highly advanced technology are already available that use artificial intelligence and make possible, among other things, sensor fusion, for example lidar, camera and radar, mapping of the environment and self-localization.

The ability to stabilize a hovering aerial drone has already advanced to the point where it is easily possible for a camera located on the aerial drone to detect a load object. Cameras integrated into the aerial drones can also be used. The payload of an aerial drone can currently be up to 15 kg, as a result of which an AI-capable computer and an additional transmitter unit can easily be carried by the aerial drone.

The use of an aerial drone makes it possible for the optical sensor carried on board the drone to detect a load flexibly, rapidly and over 360°. An additional advantage of a drone is that loads on a plurality of industrial trucks can also be detected at no additional expense.

The data processing unit is preferably also on board the aerial drone. Aerial drones are also capable of carrying compact AI modules for the analysis of the sensor data by means of artificial intelligence. Thus both the optical detection of the load and of the industrial truck can be performed by means of the optical sensor, and the sensor data can be analyzed by means of artificial intelligence on board the aerial drone. Therefore it is no longer necessary to transmit the sensor data to an external data processing unit.

The data processing unit, however, can also be on board the industrial truck itself. This is advantageous in particular if the optical sensor is attached to the industrial truck.

The data processing unit can also be stationary. In that case, the sensor data of the sensor on board the aerial drone and/or the industrial truck can advantageously be transmitted to the stationary data processing unit via a wireless data link.

It can also be advantageous to transmit sensor data from the sensor on board the aerial drone to the data processing unit on board the industrial truck by means of a wireless data link. Conversely, it can also be advantageous to transmit sensor data from the sensor on board the industrial truck to the data processing unit on board the aerial drone by means of a wireless data link.

One development of the teaching of the invention provides that at least two data processing units are used which exchange information via a wireless data link. In this manner a plurality of data processing units can be networked with one another.

In an advanced stage of construction, it is also conceivable, for example, to provide both a plurality of stationary data processing units as well as a plurality of data processing units on board aerial drones and on board a plurality of industrial trucks, all of which data processing units exchange information with one another via wireless data links. In combination with a plurality of optical sensors, some of which can be stationary and some of which can be on board the aerial drones and the industrial trucks and which transmit their sensor data to associated data processing units, it is also possible to achieve the maximum conceivable degree of networking.

An aerial drone can thereby detect the loads on a plurality of industrial trucks. For this purpose, preferably the loads of at least two industrial trucks are detected by the sensor on board the aerial drone.

The load on an industrial truck can also be detected by a plurality of aerial drones. For this purpose, the load on the industrial truck or the loads on at least two industrial trucks can be advantageously detected by the sensors on board at least two aerial drones.

According to one preferred configuration of the invention, the industrial truck and the corresponding load are detected by means of the sensor, and by analysis of the sensor data from the sensor in the data processing unit, the load data of the determined load is compared with load data previously stored in the data processing unit for the industrial truck and, if the load data differ, the load data for the industrial truck are updated.

For example, the camera on the aerial drone or another camera not attached to the industrial truck or a camera attached directly to the industrial truck detects the industrial truck and the corresponding load. The data processing unit associated with the camera compares the load data of the specified industrial truck with the load data for the industrial truck previously stored in the data processing unit. If these data differ, the data processing unit updates the load data for the industrial truck.

An additional possibility is that the aerial drone has previously received an order from the industrial truck to check and update the load on the industrial truck.

According to the invention, the following load determination criteria can be met:
1. Load dimensions (height, width, depth):
   Individual load objects of the load can be determined/recognized by analysis of the sensor data from the sensor in the data processing unit, for example by means of imaging methods and artificial intelligence, and their dimensions (height, width, depth) can be determined. From that, an overall size (height, width, depth) of the load on the industrial truck can be calculated. In this case, the use of an aerial drone has the advantage that the aerial drone can fly 360° around the load so that the optical sensor can detect the load from all sides.
2. Number of individual load objects:
   Individual load objects of the load located on the industrial truck can be determined by analysis of the sensor data from the sensor in the data processing unit and the number of load objects can be determined.
3. Weight and weight distribution of the load:
   Markers, for example QR codes, bar codes or Aruco markers of individual load objects of the load can be read out in the data processing unit by analysis of the sensor data from the sensor and the information read, in particular weight information, can be associated with the respective load object. The weight of individual load objects can thereby be associated by corresponding markers with the load objects that are read by the sensor, scanned and associated with the corresponding load object.
   A load object can also be individually determined/identified on the basis of packaging, classified and the weight of the load object can be determined from a database.
   An additional possibility is to associate the weight of the load object during loading by means of weight sensors. This method yields clear information on the weight distribution of the load.
4. Three-dimensional distribution of the load on the industrial truck:
   A three-dimensional distribution of the load on a load surface of the industrial truck can be determined by analysis of the sensor data from the sensor in the data processing unit.
   A specific distribution of the load on the load surface of the industrial truck is thereby determined on the basis of the dimensions of the individual load objects and the known size of the load surface of the industrial truck.
5. Center of gravity of the load:
   The center of gravity of the load on a load surface of the industrial truck can be determined by analysis in the data processing unit of the sensor data from the sensor.
   For this purpose, for example, the sensor on the aerial drone can detect/capture the industrial truck and the corresponding load. There are two possible ways to determine the center of gravity of the load. On one hand, the shape of the overall load can be identified and the vertical center of gravity of the load can thereby be determined, or first the geometry and the location of each individual load object can be determined by analyzing the sensor data by means of artificial intelligence. Additionally, the weight of the individual load objects can be transmitted by means of a marker such as a QR code, Aruco marker, bar code etc. An exact center of gravity of the overall load can be determined from the totality of the information collected.
   Determining the center of gravity of the load is important for autonomous platform trucks in particular because the speed and performance of the truck are continuously adjusted on the basis of the location of the center of gravity. Otherwise, the worst case must be assumed.
6. Load center distance:
   In particular when a load is picked up, the load center distance, for example, the distance of the load center of gravity from the back of a load fork, is decisive for permission to pick up a load. Without this information, a load cannot be picked up by an autonomous vehicle. The load center distance of the load can also be determined by analyzing the sensor data from the sensor in the data processing unit.
7. Quality control and pick confirmation during order picking:
   In the data processing unit, the load data of the determined load can be compared with the load data specified in the work order for the industrial truck. If the load data agree, a release is issued for the industrial truck. If the load data differ, an error message and or a return order for the industrial truck is issued.
   The problem of incorrect load picking can be solved in this manner.
   The weight and the individual dimensions of each load and optionally of the vehicle are conventionally stored in a cloud, a supply chain management system or similar databases. This information can be retrieved at any time by the data processing unit as necessary. The database information about the load could also be transmitted to the data processing unit when the work order is started to eliminate the need for communication during the order picking.
   Quality control takes place immediately during the order picking. For this purpose, for the load object currently being picked, the weight, dimensions, any markers on the load object that may be present, the position etc. are determined by means of artificial intelligence by analysis of the sensor data from the sensor. The load object determined is compared with the information for the industrial truck, for example the load data of the load objects to be picked.
   Once the load object has been correctly picked, the industrial truck receives a pick confirmation. On manually operated trucks a green light, for example, or a release to resume travel can be given. On autonomous vehicles, for example, a release to resume travel can be issued.
   An error message is generated if the picked load object is identified as incorrect for the industrial truck. On manually operated trucks this error can be signaled by means of a light or a signal to the order picking personnel. On autonomous vehicles, the vehicle can be ordered to put back the last load object picked up. This is possible because both the position of the load object as well as the position from which the load object was picked are known. Therefore a direct comparison can be performed during the execution of the work order to determine whether the order has been correctly executed.
   Finally, the determined and compared load objects can all be compared once again with the order list and confirmed to the supply chain management system in the form of a confirmation.
   The comparison with the supply chain management system can also be used to automatically take inventory. Picked load objects are thereby individually removed from the overall inventory list. The current status of the inventory can therefore be determined at any time.
   To determine inventory status, the goods received must also be checked. Here too, the invention can be used to detect goods and load objects and therefore add them to the supply chain management system.

The invention further relates to a system for the performance of the method with at least one industrial truck and one load for the industrial truck.

This system accomplishes the object of the invention in that at least one data processing unit that works with artificial intelligence and is linked with at least one optical sensor, in particular a camera, is provided, the purpose of which is to determine the load by analyzing the sensor data from the sensor.

In one advantageous configuration of the invention, the sensor is attached to the industrial truck, in particular to a lifting device on the industrial truck.

According to an additional, particularly preferred embodiment of the invention, the sensor is attached to an aerial drone.

Sensors can be attached to both the industrial truck and to the aerial drone.

Additionally or alternatively, at least one sensor can also be located in a stationary manner on an infrastructure element.

For the analysis of sensor data, the respective sensor is linked with a data processing unit which is preferably also installed on the aerial drone.

Alternatively, the data processing unit can also be installed on the industrial truck.

Data processing units can also be installed on both the industrial truck and the aerial drone.

Additionally or alternatively, a data processing unit can also be located in a stationary manner on an infrastructure element.

If a plurality of data processing units are provided, these are each linked with a data transmitting device which is designed to exchange information with at least one additional data processing device.

The data processing unit on the aerial drone is particularly preferably liked with a data transmitting device to exchange information with at least one additional aerial drone and/or the industrial truck.

The invention offers a whole series of advantages:

The operating costs of the order picking process can be reduced by quality control and picking confirmation. The invention also makes possible a fully automated load pickup. Costs for stationary load contour check stations that must be run through with each incoming load can be eliminated. Manual intervention by employees is no longer necessary. The load can easily be picked up by autonomous vehicles. The functionality of the autonomous operation of the industrial truck is not restricted. The sensor data can be processed directly in the aerial drone. Therefore wiring can be eliminated, which eliminates the risk of fire caused by moving parts. Increases in efficiency also become possible a result of gradual speed adjustments of the industrial truck, in particular of an autonomous industrial truck. The error rate in terms of incorrectly picked load objects can be significantly reduced.

### BRIEF DESCRIPTION OF THE DRAWINGS

The terms Fig., Figs., Figure, and Figures are used interchangeably in the specification to refer to the corresponding figures in the drawings.

Additional advantages and details of the invention are described in greater detail below with reference to the exemplary embodiments illustrated in the accompanying schematic figures, in which

FIG. 1 shows a system with a plurality of industrial trucks and one aerial drone,

FIG. 2 is a schematic diagram illustrating the determination of the number and dimensions of load objects,

FIG. 3 is a schematic diagram illustrating the determination of the three-dimensional distribution of load objects,

FIG. 4 is a schematic diagram illustrating the weight determination,

FIG. 5 is a schematic diagram illustrating the determination of the load center of gravity of the load, and

FIG. 6 is an illustration of the load center distance.

### DESCRIPTION OF THE INVENTION

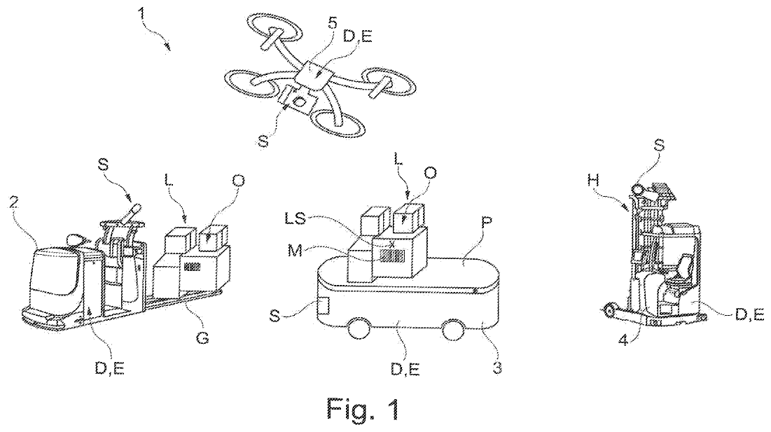

FIG. 1 illustrates a system 1 with a plurality of industrial trucks 2, 3, 4 and an aerial drone 5. The aerial drone 5 has an optical sensor S in the form of a camera and a data processing unit D which uses artificial intelligence to analyze the sensor data from the sensor S. The data processing unit D is linked to a data transmitting device E. The camera is preferably located movably on the aerial drone 5.

The industrial truck 2 is in the form of a low lift order picker with a load fork G on which the load objects O of a load L are placed. The industrial truck 2 can also have an optical sensor S in the form of a camera and a data processing unit D which uses artificial intelligence to analyze the sensor data from the sensor S. The data processing unit D can be linked to a data transmitting device E.

The industrial truck 4 has a lifting device H, for example a lifting mast, for load handling. In this case, the optical sensor S in the form of a camera is attached to the upper end of the lifting device H. This arrangement guarantees a better overview by the optical sensor S. A data processing unit D is also provided, which uses artificial intelligence to analyze the sensor data from the sensor S. The data processing unit D can be linked to a data transmitting device E.

The industrial truck 3 is in the form of an automated guided vehicle (AGV) with a lifting platform P on which the load objects O of a load L are placed. The industrial truck 3 can also have an optical sensor S in the form of a camera and a data processing unit D which uses artificial intelligence to analyze the sensor data from the sensor S. The data processing unit D can be linked to a data transmitting device E.

The load L on the industrial trucks 2, 3, 4 is determined by imaging processes. The optical sensors S and the data processing units D are provided for that purpose. The aerial drone 5 has the advantage that it can fly around the load L and thus quickly detect 360° of the load L. An additional advantage of the aerial drone 5 is that it can detect the loads L of a plurality of industrial trucks 2, 3, 4.

The optical sensor S of the aerial drone 5 makes the necessary sensor data available for analysis in the data processing unit D. The analysis of the sensor data from the sensor S in the data processing unit D is performed by means of an imaging process. Artificial intelligence methods are used for this purpose. The dimensions of the load objects O and their location and the number of the individual load objects can be determined by the analysis of the sensor data from the sensor S. The weights and the weight distribution of the load objects O can be determined by reading markers M which are applied to the load objects O. The load center of gravity LS of the load L can be determined from these values.

The sensors S on the industrial trucks 2, 3, 4 can also detect the loads L picked up and the areas around the industrial trucks 2, 3, 4. This sensor data is analyzed in the data processing units D on board the industrial trucks.

Both the aerial drone 5 and the industrial trucks 2, 3, 4 have data transmission devices E to exchange the information in the data processing unit D on board the aerial drone 5 and obtained by analysis of the sensor data of the sensor S on board the drone with the industrial trucks 2, 3, 4 and optionally to compare it with the information in the data processing units D on board the industrial trucks and obtained by analysis of the sensor data of the sensor S on board the industrial trucks.

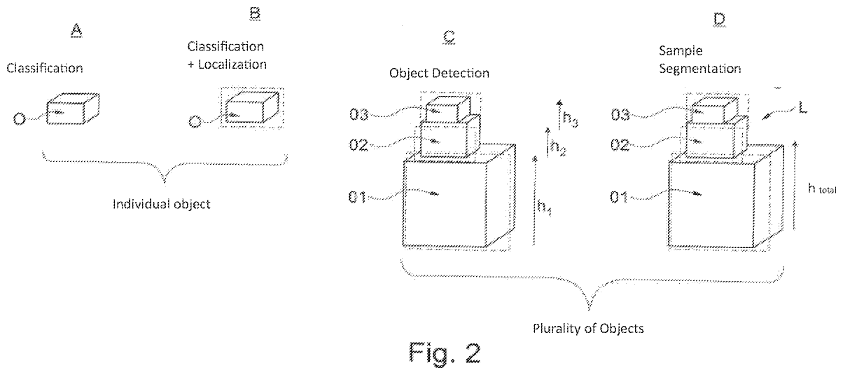

In FIG. 1, the load L on one of the industrial trucks 2, 3, 4 or on a plurality of industrial trucks 2, 3, 4 is determined, preferably with the aerial drone 5 and its camera. As described below with reference to FIGS. 2 to 6, as factors of the load L, the dimensions of the load L, the number of individual load objects O1, O2, O3, the weight and the weight distribution of the load L, the three-dimensional distribution of the load L on the industrial truck 2, 3, 4 and the center of gravity of the load as well as the load center distance of the load L can be determined. These factors of the load L can be transmitted via the data transmitter devices E from the aerial drone 5 to the corresponding industrial truck 2, 3, 4.

As illustrated in FIG. 2, the individual load objects O, O1, O2, O3 of a load L can be determined and their dimensions, for example the height, width and depth, as well as the number of the load objects O1, O2, O3 can be determined by means of imaging processes and artificial intelligence. An individual load object O can be classified in a step A and localized in a step B. In a collection of a plurality of load objects O1, O2, O3, the individual load objects O1, O2, O3 can first be detected in a step C and their dimensions, of which only the heights h1, h2, h3 are indicated in FIG. 2, can be determined. From the heights h1, h2, h3 of the load objects O1, O2, O3, a total height h of the load L can be calculated. Accordingly, the overall dimensions (width, depth) of the load L can be determined from the other dimensions measured (width, depth).

The dimensions of the load objects O, O1, O2, O3 can be determined, for example, during the loading of the industrial truck 2, 3, 4.

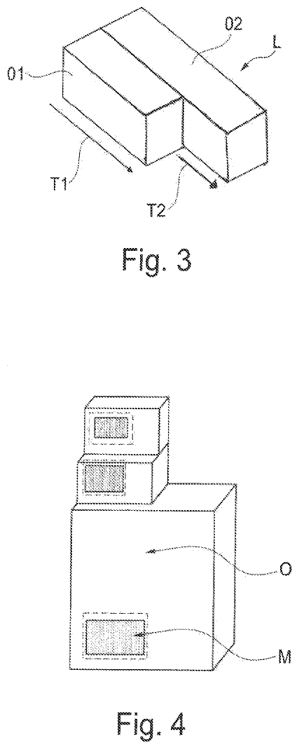

As illustrated in FIG. 3, encircled load objects O2 can also be measured by first detecting the neighboring load object O1, determining its depth T1 and then adding the projecting portion of the load object O2, which results in the depth T2 of the load object O2. The aerial drone 5 thereby checks whether the load objects O1, O2 end in a plane on the back end.

On the basis of the dimensions of the individual load objects O1, O2 and the known dimensions of the load area of the industrial truck 2, 3, 4 not shown in FIG. 2 or 3, a concrete three-dimensional distribution of the load L on the load area of the industrial truck 2, 3, 4, which is also detected by the sensor S, is determined. Space available for order picking can thereby be utilized by the industrial truck 2, 3, 4.

FIG. 4 is a schematic diagram of the determination of the weight. The weight of individual load objects O can be transmitted by markers M, for example QR codes, bar codes, Aruco markers etc. to the aerial drone 5, in which the sensor S on board the aerial 5 drone detects the corresponding marker M, and the data processing unit D on board the aerial drone 5 reads the marker M by analyzing the sensor data of the sensor S, and associates this information with the load object O.

The weight distribution of the load can be determined if, by means of additional sensors such as weight sensors, for example, the weight is associated with the load object during loading.

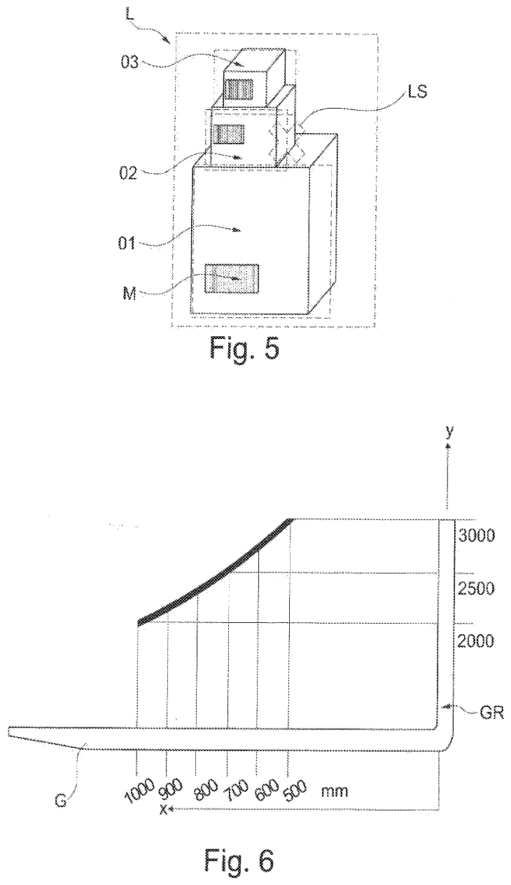

FIG. 5 is a schematic diagram of the determination of the load center of gravity LS of the load L. First, the load objects O1, O2, O3 are detected by the sensor S of the aerial drone 5 and the geometry and location of each individual load object O1, O2, O3 are determined by analysis of the sensor signals of the sensor S in the data processing unit D of the aerial drone 5 by means of artificial intelligence. The weight of the individual load objects O1, O2, O3 can also be determined by means of a corresponding marker M, such as a QR code, Aruco marker, bar code etc. On the basis of the totality of the information, an exact load center of gravity LS of the total load L is determined, in particular the vertical height of the load center of gravity LS of the load L, and the horizontal load center distance of the load L.

In particular for the autonomous industrial truck 3 with a lifting platform, the load center of gravity, in particular the vertical height of the load center of gravity LS, of the load L is important because the speed and performance of the autonomous industrial truck 3 can thereby be continuously adjusted.

FIG. 6 shows a capacity diagram to illustrate the horizontal load center distance. The load weights are plotted on the vertical axis y and the load center distance is plotted on the horizontal axis x. The capacity diagram schematically indicates the conditions on, for example, the load fork G of an industrial truck 2, 3, 4. The x axis thereby corresponds to the load fork G and the y axis the back of the fork GR. If the load is on the load fork G of the industrial truck 2, 3, 4, the load center distance is the distance of the load center of gravity LS from the back of the fork GR.

In particular for an autonomous industrial truck, when the load is picked up, the load center distance of the load L is decisive for permission to pick up a load. Without this information, a load cannot be picked up by an autonomous vehicle.

1. A method for the determination on of a load on an industrial truck, comprising: detecting the load by at least one optical sensor; and determining the load by analysis of sensor data from the optical sensor using artificial intelligence in at least one data processing unit.

2. The method according to claim 1, wherein a camera is used as the optical sensor.

3. The method according to claim 1, wherein that the optical sensor is onboard the industrial truck.

4. The method according to claim 3, wherein the optical sensor is located on a lifting device of the industrial truck.

5. The method according to claim 1, wherein the optical sensor is located outside the industrial truck.

6. The method according to claim 5, wherein in the optical sensor is onboard an aerial drone.

7. The method according to claim 6, wherein the data processing unit is onboard the aerial drone.

8. The method according to claim 1, wherein the data processing unit is onboard the industrial truck.

9. The method according to claim 1, wherein the data processing device is operated in a stationary manner.

10. The method according to claim 1, wherein that the sensor data of the optical sensor is transmitted to the data processing unit via a wireless data link.

11. The method according to claim 1, wherein at least two data processing units are used which exchange information via a wireless data link.

12. The method according to claim 1, wherein the analysis of the sensor data of the optical sensor is performed in the data processing unit by an imaging process.

13. The method according to claim 1, wherein the industrial truck and the load are detected by the optical sensor, and by an analysis of the sensor data from the optical sensor in the data processing unit, load data of the determined load is compared with data previously stored in the data processing unit for the industrial truck and, in the event of a variance of the load data, the load data for the industrial truck is updated.

14. The method according to claim 7, wherein loads of at least two industrial trucks are detected by the optical sensor onboard the aerial drone.

15. The method according to claim 7, wherein the load of the industrial truck or loads of at least two industrial trucks detected by the optical sensor onboard the aerial drone.

16. The method according to claim 1, wherein individual load objects of the load are determined by analysis of the sensor data of the optical sensor in the data processing unit and their dimensions are determined and from their dimensions, an overall size of the load is calculated.

17. The method according to one claim 1, wherein the individual load objects of the load are determined by analysis of the sensor data of the optical sensor performed in the data processing unit and their number is determined.

18. The method according to claim 1, wherein markers of individual load objects of the load are read by analysis of the sensor data of the optical sensor in the data processing unit and the information read is associated with the respective individual load objects.

19. The method according to claim 1, wherein a three-dimensional distribution of the load on a load area of the industrial truck is determined in the data processing unit by analysis of the sensor data of the optical sensor.

20. The method according to claim 1, wherein a load center of gravity of the load is determined in the data processing unit by analysis of the sensor data of the optical sensor.

21. The method according to claim 1, wherein in the data processing unit, load data of a determined load is compared with load data of the load specified in a work order for the industrial truck, whereby if the load data agree, a release is issued for the industrial truck, and if the load data differ, an error message and or a return work order for the industrial truck is issued.

22. A system for the determination of a load on an industrial truck comprising at least one data processing unit working with artificial intelligence and linked with at least one optical sensor, wherein the data processing unit is capable of determining the load by analyzing sensor data of the optical sensor.

23. The system according to claim 22, wherein the optical sensor is attached to the industrial truck.

24. The system according to claim 22, wherein the optical sensor is attached to an aerial drone.

25. A system according to claim 22, wherein the data processing unit is installed in the aerial drone.

26. The system according to claim 25, wherein characterized in that the data processing unit is linked with a data transmitting device, which exchanges information with at least one additional aerial drone and/or the industrial truck.

27. The system according to claim 23, wherein the optical sensor is attached to a lifting device of the industrial truck.
